(19) United States
(12) Patent Application Publication
(10) Pub. No.: US 2016/0141061 A1
(43) Pub. Date: May 19, 2016

(54) SYSTEM AND METHOD FOR PRODUCING TECHNETIUM-99M USING EXISTING PET CYCLOTRONS

(71) Applicant: Eric A. Burgett, Pocatello, ID (US)

(72) Inventor: Eric A. Burgett, Pocatello, ID (US)

(21) Appl. No.: 14/727,528

(22) Filed: Jun. 1, 2015

Related U.S. Application Data
(60) Provisional application No. 62/006,457, filed on Jun. 2, 2014.

(51) Int. Cl. G21G 1/00; G21G 1/10

(52) U.S. Cl. CPC G21G 1/001; G21G 1/10; G21G 2001/0042

(57) ABSTRACT

The present invention relates generally to a system and method for producing Technetium-99m. More specifically, the present invention relates to a novel method and device for modifying commercially-available, widely-used low energy positron emission tomography (PET) cyclotrons in order to produce Technetium-99m in a more efficient, less expensive manner that previously known.

### CROSS-REFERENCE TO RELATED APPLICATIONS

The present application claims priority to and the benefit of the filing date of U.S. Provisional Patent Application Ser. No. 62/006,457, filed Jun. 2, 2014, which is incorporated herein by reference.

### BACKGROUND OF THE INVENTION

The present invention relates generally to a system and method for producing Technetium-99m. More specifically, the present invention relates to a novel method and device for modifying commercially-available, widely-used low energy positron emission tomography (PET) cyclotrons in order to produce Technetium-99m in a more efficient, less expensive manner than previously known.

Technetium-99m (Tc-99m) is used in medical therapy in brain, bone, liver, spleen, kidney, and thyroid scanning and for blood flow studies and is the most widely used medical isotope in the world. Tc-99m is the radioisotope most widely used as a tracer for medical diagnosis. Technetium-99m is used in 20 million diagnostic nuclear medical procedures every year, half of which are bone scans, and the other half are roughly divided between kidney, heart and lung scans. Approximately 85 percent of diagnostic imaging procedures in nuclear medicine use this isotope. Currently, this isotope is produced worldwide in a small number of research reactors. A number of these reactors are likely to close in a few years leading to supply shortages. Additionally, these reactors must use highly enriched uranium to produce Tc-99m. It is a long-standing goal to eliminate the use of highly enriched uranium in research reactors due to security concerns. Currently, there are no domestic supplies, and the United States imports Tc-99m from Canada. Secure, economic domestic supply is of interest to the US.

A cyclotron is a type of particle accelerator in which charged particles accelerate outwards from the center along a spiral path. The particles are held to a spiral trajectory by a static magnetic field and accelerated by a rapidly varying (radio frequency) electric field. The cyclotron was an improvement over the linear accelerators (linacs) that were available when it was invented, being more cost- and space-effective due to the iterated interaction of the particles with the accelerating field. In the 1920s, it was not possible to generate the high power, high-frequency radio waves which are used in modern linacs (generated by klystrons). As such, impractically long linac structures were required for higher-energy particles. The compactness of the cyclotron reduces other costs as well, such as foundations, radiation shielding, and the enclosing building. Cyclotrons have a single electrical driver, which saves both money and power. Furthermore, cyclotrons are able to produce a higher duty factor stream of particles at the target, so the average power passed from a particle beam into a target is relatively high.

The spiral path of the cyclotron beam can only “sync up” with klystron-type (constant frequency) accelerating sources if the accelerated particles are approximately obeying Newton's Laws of Motion. If the particles become fast enough that relativistic effects become important, the beam becomes out of phase with the oscillating electric field, and cannot receive any additional acceleration. The classical cyclotron is therefore only capable of accelerating particles up to a several percent of the speed of light. To accommodate increased mass, the magnetic field may be modified by appropriately shaping the pole pieces as in the isochronous cyclotrons, operating in a pulsed mode and changing the frequency applied to the dees as in the synchrocyclotrons, either of which is limited by the diminishing cost effectiveness of making larger machines. Cost limitations have been overcome by employing the more complex synchrotron or modern, klystron-driven linear accelerators, both of which have the advantage of scalability, offering more power within an improved cost structure as the machines are made larger.

A radio-frequency quadrupole (RFQ) is a linear accelerator component generally used at low beam energies, roughly 50 keV to 3 MeV. It is similar in concept to a quadrupole mass analyzer but its purpose is to accelerate a single-species beam (rather than perform mass spectrometry on a multiple-species beam). The RFQ is a combined-function component that both accelerates and focuses the beam of charged particles.

Positron emission tomography (PET) is a nuclear medical imaging technique that produces a three-dimensional image or picture of functional processes in the body. The system detects pairs of gamma rays emitted indirectly by a positron-emitting radionuclide (tracer), which is introduced into the body on a biologically active molecule. Three-dimensional images of tracer concentration within the body are then constructed by computer analysis. In modern scanners, three-dimensional imaging is often accomplished with the aid of a CT X-ray scan performed on the patient during the same session, in the same machine.

If the biologically active molecule chosen for PET is FDG, an analogue of glucose, the concentrations of tracer imaged will indicate tissue metabolic activity by virtue of the regional glucose uptake. Use of this tracer to explore the possibility of cancer metastasis (i.e., spreading to other sites) is the most common type of PET scan in standard medical care (90% of current scans). However, on a minority basis, many other radiotracers are used in PET to image the tissue concentration of many other types of molecules of interest.

To conduct the scan, a short-lived radioactive tracer isotope, e.g., fluorine-18, is injected into the living subject (usually into blood circulation). The tracer is chemically incorporated into a biologically active molecule. There is a waiting period while the active molecule becomes concentrated in tissues of interest; then the subject is placed in the imaging scanner. The molecule most commonly used for this purpose is fluorodeoxyglucose (FDG), a sugar, for which the waiting period is typically an hour. During the scan a record of tissue concentration is made as the tracer decays.

As the radioisotope undergoes positron emission decay (also known as positive beta decay), it emits a positron, an antiparticle of the electron with opposite charge. The emitted positron travels in tissue for a short distance (typically less than 1 mm, but dependent on the isotope), during which time it loses kinetic energy, until it decelerates to a point where it can interact with an electron. The encounter annihilates both electron and positron, producing a pair of annihilation (gamma) photons moving in approximately opposite directions. These are detected when they reach a scintillator in the scanning device, creating a burst of light which is detected by photomultiplier tubes or silicon avalanche photodiodes (Si APD). The technique depends on simultaneous or coincident detection of the pair of photons moving in approximately opposite direction.

There are various systems and methods for producing radioisotopes. The PET isotope production cyclotron accelerator is originally designed with energies of up to 18 MeV for the production of PET isotopes. The production of Tc-99m from molybdenum-100 (Mo-100) requires a significantly higher energy to efficiently produce this isotope. The proposed system increases the energy output of existing cyclotron systems while providing the ability to produce several other isotopes which were previously unable to be produced in these accelerators. The following chart includes a list of patents and published patent applications that are directed to this type of technology. Each of these references is incorporated by reference herein:

| Patent Number | Title | PI |
|---|---|---|
| EP 2428103 A1, | Isotope production system and | Tomas Erickson, |
| U.S. Pat. No. 8,106,370 B2, | cyclotron having a magnet yoke | Jonas Norling |
| US 20100282979 A1 | with a pump acceptance cavity | |
| EP 1120025 A1 | Device for fitting of a target in | Peter Wiberg |
| U.S. Pat. No. 6,433,495 B1 | isotope production | |
| EP 2446717 A1 | Isotope production system with | Tomas Erickson, |
| US 20100329406 A1 | separated shielding | Jonas Norling |
| EP 1125304 A1 | Integrated radiation shield | Olof Jan |
| U.S. Pat. No. 6,392,246 B1 | | BERGSTRÖM, |
| | | Peter Wiberg |
| EP 0840538 A2 | Target for use in the production | Martin Finlan |
| | of heavy isotopes | |
| U.S. Pat. No. 5,874,811 A | Superconducting cyclotron for | Martin Finlan |
| | use in the production of heavy | |
| | isotopes | |
| EP 2561727 A1 | Self-shielding target for isotope | Tomas Eriksson, |
| US 20110255646 A1 | production systems | Ove Jonas Norling |
| EP 1989929 A1 | Proton accelerator complex for | Ugo Amaldi |
| U.S. Pat. No. 7,554,275 B2 | radio-isotopes and therapy | |
| US 20110091001 A1 | High current solid target for | Min Goo Hur |
| | radioisotope production at | |
| | cyclotron using metal foam | |
| EP 1736997 B1 | System for automatic production | Paolo Bedeschi |
| U.S. Pat. No. 8,233,580 B2 | of radioisotopes | |
| US 20120321026 A1 | Target apparatus and isotope | Jonas Norling, |
| | production systems and methods | Tomas Erickson |
| | using the same | |
| US 20120307953 A1 | General Radioisotope Production | Nigel Raymond |
| | Method Employing PET-Style | Stevenson |
| | Target Systems | |
| U.S. Pat. No. 6,143,431 A | Production of Palladium-103 | Brian A. Webster |
| U.S. Pat. No. 5,037,602 A | Radioisotope production facility | Ali E. Dabiri, |
| | for use with positron emission | William K. Hagan |
| | tomography | |
| US 20070297554 A1 | Method And System For | Alexander |
| | Production Of Radioisotopes, | Arenshtam |
| | And Radioisotopes Produced | |
| | Thereby | |
| U.S. Pat. No. 5,784,423 A | Method of producing | Richard Lanza, |
| | molybdenum-99 | Lawrence M. Lidsky |
| US 20120281799 A1 | Irradiation Device and Method | Douglas P. Wells, |
| | for Preparing High Specific | Frank Harmon |
| | Activity Radioisotopes | |

### BRIEF SUMMARY OF THE INVENTION

Among the several objects of this invention may be noted the provision of an apparatus for, as described and shown herein, a modification to existing positive or negative ion accelerator and associated facility, primarily a PET isotope production facility cyclotron, to enhance its isotope production capabilities and allow such devices to produce Tc-99m through the use of a secondary accelerator structure.

### BRIEF DESCRIPTION OF THE DRAWINGS

FIG. 1 is a side view of a micro or nanostructured array of the present invention.

FIG. 2 is a side view of a second embodiment of a micro or nanostructured array of the present invention.

FIG. 3 is a schematic diagram of a prior art accelerator system.

FIG. 4 is a schematic diagram of an accelerator system illustrating a first method for boosting charged particle beams according to the present invention

FIG. 5 is a schematic diagram of an accelerator system illustrating a second method for boosting charged cold isotope separation charged particle beams according to the present invention.

FIG. 6 is a schematic diagram of an accelerator system illustrating a target end station showing the ablating end station according to the present invention.

FIG. 7 is a schematic diagram of an accelerator system illustrating a multiple-orifice, dynamically vacuum-pumped beam delivery system according to the present invention.

FIG. 8 is a schematic diagram of an accelerator system illustrating a method of determining the threshold energy for transmutation/isotope production.

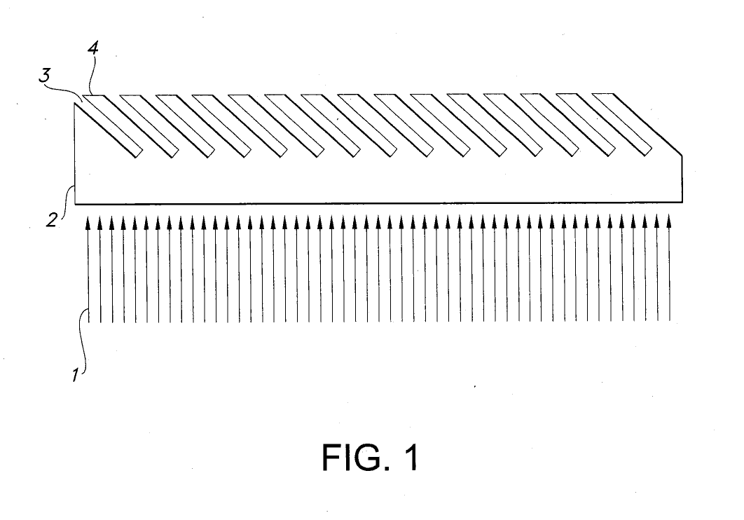

More specifically, FIG. 1 is a diagram representing a micro or nanostructured array wherein the charged particle beam 1 (represented by arrows) is incident on the opposite side of the target 2. Cooling is provided in the interstitial space 3. The thickness of the target 2 and resulting nano/micro structured pillars 4 created from the trenches etched into the target 2 is dependent on the range of the charged particle and maximized to collect recoil nuclei which exit the array.

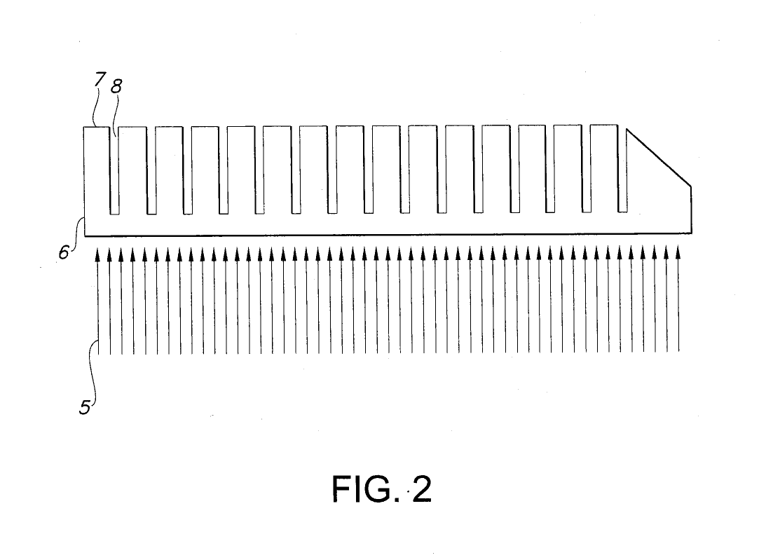

More specifically, FIG. 2 is a diagram representing a micro or nanostructured array wherein the charged particle beam (represented by arrows) 5 is incident on the opposite side of the target. A sacrificial material is placed in the void spaces 8. This material is removed through etching or chemical extraction leaving the remainder of the un-activated materials behind 7. The thickness of the target 6 is dependent on the range of the charged particle and maximized to collect recoil nuclei which exit the array.

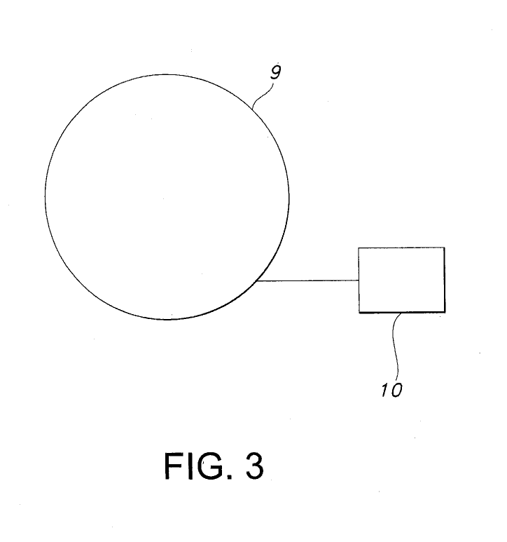

More specifically, FIG. 3 is a diagram representing an existing accelerator system. The cyclotron 9 is directly connected to an end station 10.

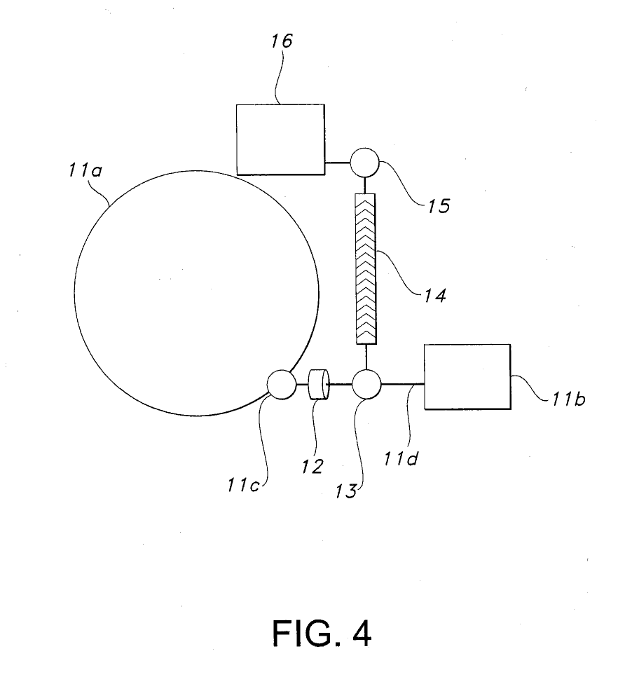

More specifically, FIG. 4 is a diagram representing a proposed addition to existing accelerator system for boosting charged particle beams. In the system the beam leaves the existing accelerator system 11 and passes through a timing pickoff mechanism 12. This mechanism is either an solenoid, inductive pickup, a multiwire detector, or the kicker magnet power supply feeding the accelerator or similar timing generating system. The beam then passes through a dipole (standard 90 degree or achromatic 270) magnet and is then focused 13. The beam then enters into the accelerator cavity where it is boosted in energy 14. The beam then passes through a dipole (standard 90 degree or achromatic 270) magnet and is then focused 15. The beam is then focused onto the end station where the beam is diffused, rastered, or used to pattern and deposit materials 16.

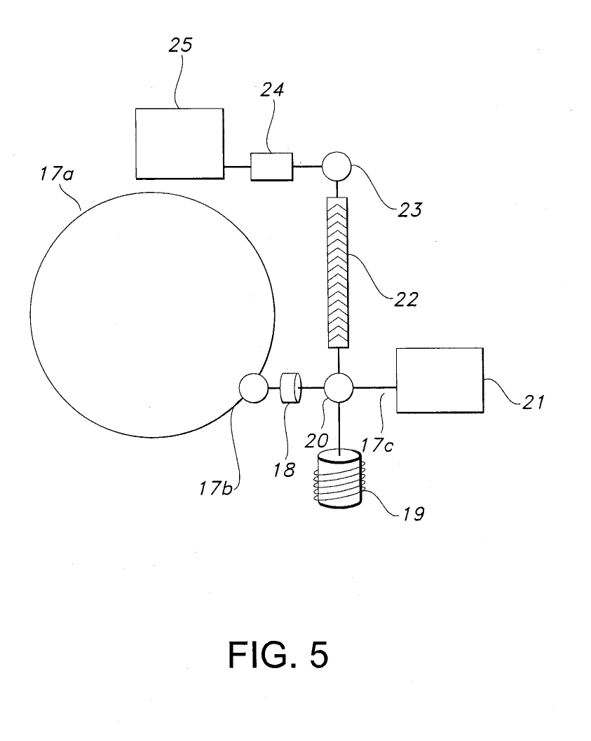

More specifically, FIG. 5 is a diagram representing a proposed addition to existing accelerator system 17, 21 for cold isotope separation charged particle beams. In the system the beam is generated in a secondary ion source system 19, either negative or positive ions. This mechanism is either a SNICS, torvus, RF plasma, DC Plasma or the like. The beam then passes through a dipole (achromatic 270 or offset achromatic) 20 magnet and is then focused. The beam then enters into the accelerator cavity 22 where it is boosted in energy. The beam then passes through a dipole (standard 90 degree or achromatic 270) magnet and is then focused 23. The beam is then focused using a focusing or scanning magnet 24 onto the end station 25 where the beam is diffused, rastered, or used to pattern and deposit materials.

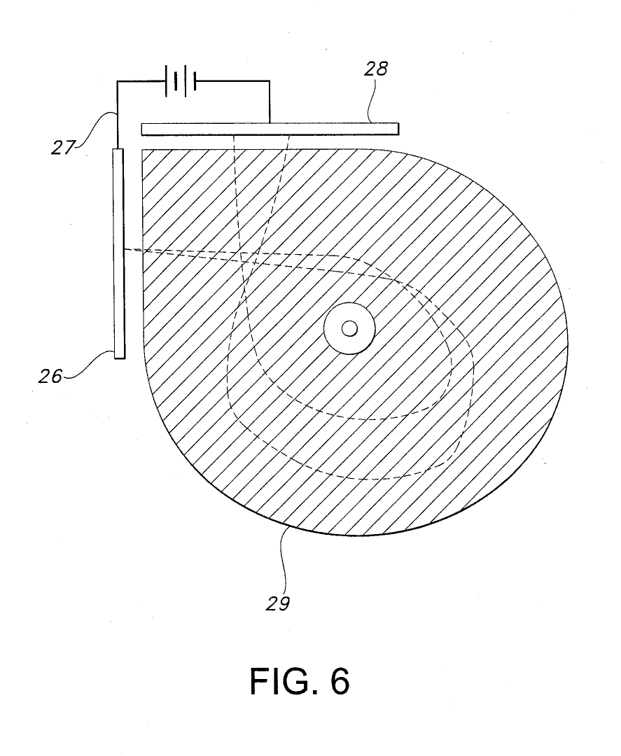

More specifically, FIG. 6 is a diagram representing a proposed target end station showing the ablating end station. Shown is the schematic for the high voltage bias 27 providing the acceleration needed to attract the particles to the end plate. The large and short dashed lines provides rough trajectories of high energy and low energy particles emitted from the target to the collector.

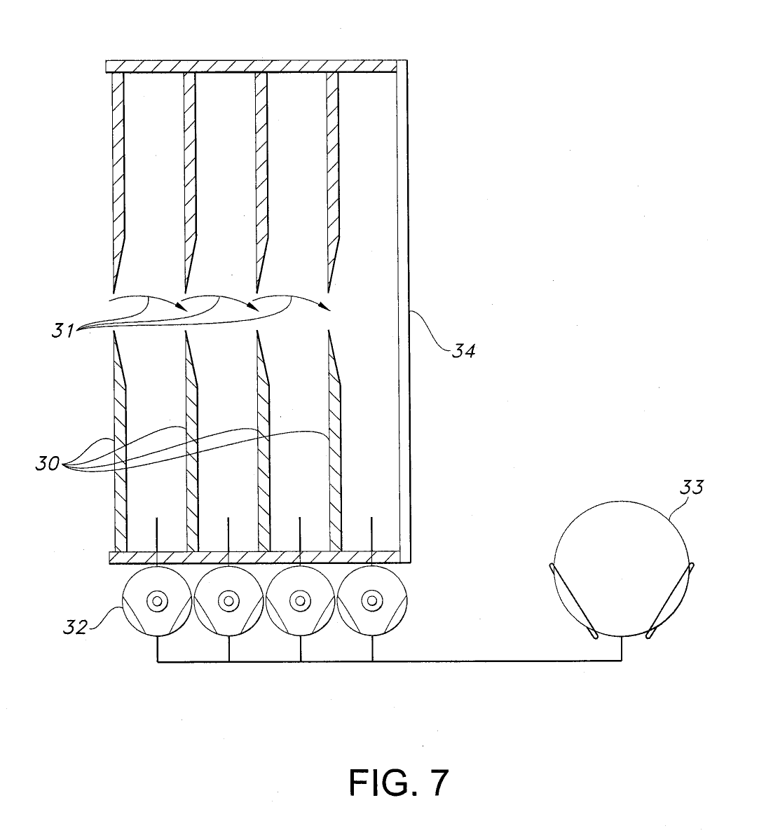

More specifically, FIG. 7 is a diagram of a multiple-orifice, dynamically vacuum-pumped beam delivery system.

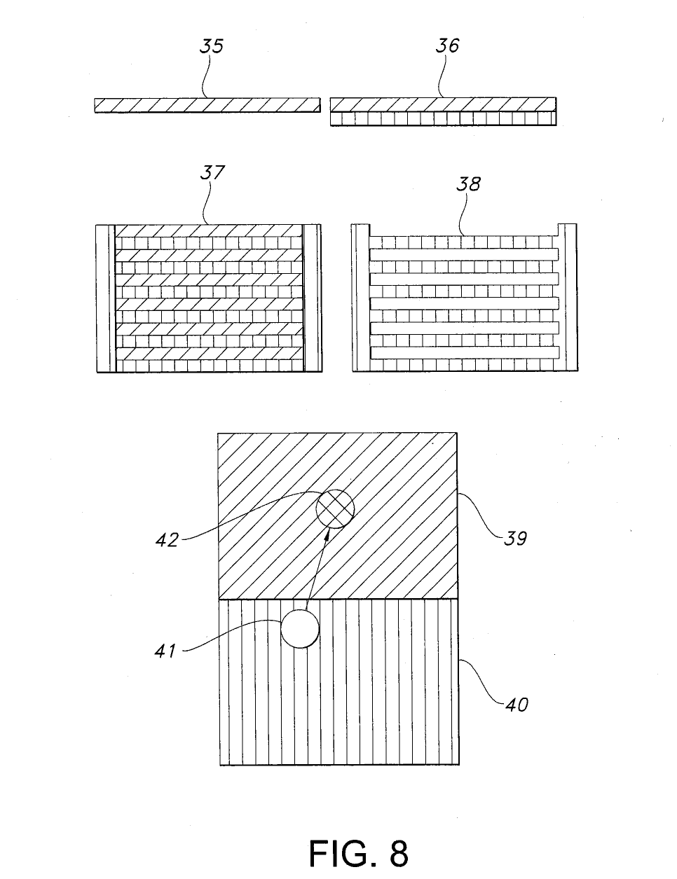

More specifically, FIG. 8 is a diagram of the prior systems using nanostructured patterning, wherein the beam energy is used to determine the maximum range the particle can travel before the energy falls below the threshold energy for transmutation/isotope production.

### DETAILED DESCRIPTION OF THE INVENTION

In accordance with one aspect of the invention, a linear accelerator and control technology allow accelerated protons that are produced by a commercially-available, widely-used low energy PET cyclotron/accelerator to be further accelerated to a higher energy, allowing them to reach the energies needed to efficiently produce significant quantities of Tc-99m. An innovative target is also provided that allows for efficient collection and processing of the desired isotope. One embodiment of the present invention includes a device, target, and processes to allow existing commercial PET cyclotrons to produce technetium-99m. This system allows local production of Tc-99m in facilities that currently produce only PET isotopes, e.g., fluorine-18. Deployment of the technology may alleviate the supply shortage of Tc-99m. Local production could also result in lower costs for production and use of Tc-99m. This technology can also be used for the production of other useful isotopes, radioactive (“hot”) as well as stable (“cold”), see Tables 1 and 2 for a non-exhaustive list of examples.

TABLE 1
Radioactive “hot” Isotopes

Aluminum-26
Arsenic-74
Bismuth-205
Bismuth-206
Bromine-77
Bromine-80m
Cobalt-57
Copper-61
Copper-64
Copper-67
Gallium-67
Gandolinium-148
Hafnium-172
Indium-111
Iodine-123
Iodine-124
Iron-52
Krypton-81m
Lead-200
Magnesium-28
Palladium-103
Rubidium-81
Ruthenium-97
Silicon-32
Sodium-22
Strontium-82
Technetium-99m
Thallium-201
Vanadium-48
Xenon-127
Yttrium-88
Zirconium-89

TABLE 2
Stable “cold” Isotopes

Bismuth-209
Bromine-81
Cadmium-111
Cesium-133
Copper-65
Germanium-74
Iodine-127
Iron-57
Lead-207
Manganese-55
Molybdenum-100
Nickel-64
Phosphorus-31
Polonium-208
Polonium-209
Polononium-210
Rhodium-103
Selenium-77
Selenium-80
Strontium-88
Tellerium-124
Thalium-203
Titanium-48
Yttrium-89
Zinc-67
Zinc-68

The current low-energy PET isotope producing accelerators in wide use around the United States are based on a cyclotron accelerator technology. These technologies are rather simplistic in nature and are a mature and reliable technology. These technologies are designed to maximize PET isotope production, which have much lower production threshold energies. This can be seen in FIG. 3. The existing cyclotron accelerator 9 accelerates a beam of charged particles to an end station 10. For the new embodiment of this technology utilizing FIG. 4, the cyclotron design 11a produces short bursts of accelerated protons. These short bursts arrive at the target location 11b with a very well-known time structure. In one embodiment, a RFQ or linac accelerator 14 is coupled to the output of the cyclotron to boost the energy of the emerging protons to the energy needed to efficiently produce Tc-99m. A key advancement is to synchronize the RFQ and or linac accelerator with the time structure of the emerging protons which exit the accelerator through the beam exit port or beam window. The RFQ and or linac structure is of a standing or traveling wave type accelerator where the resonance frequency of the cavity structure is in the MHz to THz frequency domains. To maximize the RFQ or linac structure's temporal acceptance of the charged particle beam, the microwave MHz to THz frequency drive is locked in phase with the cyclotron itself with the initial cavities resonating at fractional or multiple harmonics of the cyclotron itself. The reminder of the cavity can operate independently in the MHz to THz frequencies. If the time structure is known, the radio-frequency cavity can be time-synched with the proton time microstructure. This time synching is used to generate the accelerating microwave field produced in the klystron which drives the radiofrequency (RF) accelerator field. If this time structure is not known, or cannot be measured from the magnet, oscillator, or kicker magnet; a solenoid inductive pickup, or wire detector 12 can provide the required time structure information. This pickoff coupled with a drift tube (an accelerator tube where no outside forces act on the beam while the signal produced in 12 One embodiment of this invention would be a bolt-on capability 11c,11d that can be retrofitted onto existing technology, thereby potentially providing a large number of geographically-distributed accelerators capable of producing this much-needed isotope. This bolt on capability is designed to be robotically isolated from the accelerator itself and moved into and out of place remotely to maximize the capabilities of the exiting PET cyclotron. Gate valves and pneumatic connections maintain isolation between components and provide a capability to move the proposed bolt on capability into and out of the beam path for the cyclotron when not in use. The proposed system and required vacuum components as well as structural components required for the installation of this equipment provide adequate radiation shielding to the unit, thereby not requiring additional shielding to be installed with this bolt on capability. This additional shielding is accomplished through strategic placement of key components producing radiation rendering the unit “Self Shielding” or not requiring external shielding additions.

An additional enhancement to the PET Cyclotron is the installation of a second ion source 19 separate from that of the cyclotron, such as SNICS, Torvus, plasma, sputter, spallation and the like, which would be coupled to the RFQ cavity when it is not attached to the PET cyclotron to serve as a target material enrichment device. For example, 17A (the main cyclotron system), 17 B connects to a shutoff valve and beam transport tube to 17 C and the existing target end station while parts 19-25 are isolated). During this phase, the ion source will be utilized to accelerate a high current source of negative or positive ions of the target nuclei. The nuclei are ionized in the ion source 19 and are accelerated to the linac/RFQ accelerator source 22. These nuclei then undergo acceleration in the accelerator cavity. Once accelerated, the nuclei are then sent through a doubly achromatic 270 degree bending (two or three segment) dipole bending magnet with a suitable set of adjustable slit apertures behind which is a moveable target 23. The addition of multiple isotope collectors in the 270 degree bending magnet allows for simultaneous separation and collection of various isotopes due to their energy and mass differences. As a bending magnet, this magnet provides both simultaneous bending and superior focusing of a wide bandwidth (energy) of accelerated atomic species. These nuclei will be brought incident onto a target for collection 25. The series of focusing quadrapole and 270 degree bending dipole magnets are used to select the desired mass and charge of the accelerated beam thereby enriching the target nuclei for use in the secondary system. The selected beam can defocused/focused onto the target in a diffuse setting or can be steered with focusing magnets to produce a micro/nanostructured target to assist in online/offline processing. The Tc-99m production target may be comprised of a cold target of either enriched material produced above, or natural isotopic abundance target material (Molybdenum). It can be aqueously separated using conventional techniques, online separated through aqueous flow over/under the target, as seen in FIG. 1 or 2), enhanced through nano and microsctructured patterning 4, 8, or can be of a novel form described below. The nano/micro structured target can 1) improve surface area and thereby extraction efficiency for the selected isotope, and/or 2) can be used to collect the resulting activated isotope through kinematic recoil.

The target can also be produced such that it is a diffuse disc or other geometric shape of material also known as a collector grid. As shown in FIG. 6, preferably, the target itself is at an elevated potential at the end of a focusing/bending magnet 27. As the target is irradiated, the trapped protons embrittle and build pressure internally due to the hydrogen helium or deuterium being implanted. After sufficient irradiation-induced pressure and embrittlement is accumulated, the target spalls single atoms, multiple atoms, or fragments containing the desired isotope of Tc-99m from the target. The spalled atoms, subjected to the accelerating voltage 27 because they are being emitted in directions not co-linear with the accelerated beam, are accelerated off of the target towards a collector. The incident beam will not be affected as it passes through the neutral zone in the center of the quadrapole or dipole magnet. The vast majority of the spalled fragments will be captured because the probability of spalling directly perpendicular to the surface, collocated with the incident beam is exceptionally low. The collector is then processed online or offline, resulting in a very pure isotopic content of Tc-99m with very high specific activities.

An innovative target is presented to provide for efficient collection and processing of the desired radioisotope. Key aspects of the invention include micro or nano-structured patterns, flooding the target with free electrons, and imparting a vacuum on the target. Other innovations include a self-ablating target design and/or the use of a liquid target coupled with online processing to allow fresh target material to remain present to the charged particle beam.

### Microstructured/Nanostructured Patterning

The nanostructured and micro-structured pillar provides three main advantages over a traditional one-dimensional target structure. The first is the improved surface area which is exposed to the charged particle beam and is described above. The second is the improved cooling efficiency of the micro/nanostructured material. The improved surface area improves the cooling of the target allowing for higher beam currents to be applied to the target while still maintaining the target's integrity. The last major improvement is in the ability to extract the irradiated nuclei during operation of the accelerator (“online”).

To improve the efficiency of a target, high aspect ratio pillar-like micro- or nano-scale structures can be additively constructed out the target isotope material (see FIG. 1). This method is particularly useful for target isotope materials that are rare or expensive, such as Molybdenum-100 used to produce techeticum-99m. Methods to produce the pillar-like nano and micro structures can include: e-beam sintering, direct laser sintering, direct liquid metal writing, direct ink jet printing, ion-assisted deposition, e-beam assisted deposition, patterned atomic layer deposition, patterned vapor deposition i.e., chemical vapor deposition (CVD), metal organic chemical vapor deposition (MOCVD), plasma-enhanced chemical vapor deposition (PECVD), laser-assisted chemical vapor deposition (LACVD), or the like.

For target materials that are relatively abundant or inexpensive, a subtractive technique can be used to fabricate high aspect ratio trench-like micro or nano-structures. Various type of subtractive techniques including: laser micro machining or a masked etching technique such as reactive ion etching, plasma-enhanced reactive ion etching, or chemical etching, or the like, can be used to selectively remove target material to develop the micro- or nano-scale trench-like structures, as shown in FIG. 2. The subtractive technique limits the overall aspect ratio of the trench because of the limited anisotropy of the etching methods used.

The high aspect ratio pillars or trenches are aligned at an angle with respect to the incident charged particle beam so as to maximize penetration of the charged particles into the target. The angle should be minimized with respect to the incident particle beam to maximize the amount of target material seen by the charged particle beam, i.e., maximize the number of pillars per unit area or minimize the number of trenches per unit area. The thickness of the trench structure 4, as shown FIGS. 1 and 2, is selected to avoid shadowing of one pillar from the next i.e. the tip of one pillar lines up with the base of the subsequent pillar. The thickness of the trench structure 3 is also selected to maximize the self-wicking effect of the coolant and to ensure laminar flow, and prevent turbulent flow of the coolant through the trench/pillar structures.

The height of the pillar 6 will be limited to the physical strength of the pillars themselves as a function of the physical characteristics of the target material, coolant, and the density (g/cc) of the pillars relative to theoretical which are grown. The additive technique can provide a higher aspect ratio of the two options due to its higher degree of anisotropic growth compared to the subtractive etching techniques.

The thickness of the pillars 7, or the distance between trenches, is engineered such that the thickness is five times the average expected range of the charged particle beam in the target material.

To improve cooling of the micro/nanostructured materials, a low-pressure coolant (liquid or gas) is flowed over them in trenches 3,8. Traditional designs require coolant to flow over the back of solid production targets. The amount of heat that is able to be removed is limited in this configuration due to the low thermal conduction of the target material coupled with the localized heating on the surface. In most charged particle beams, there is intense localized heating. With high beam currents this can result in melting and destruction of the target. In this invention, the micro/nanostructured materials are contiguous and the coolant flow rate is kept low so as to maintain laminar flow in the micro/nanostructured pillars and trenches. Laminar flow provides improved cooling and this design is a significant improvement over existing one-dimensional target technologies.

The use of micro- and nano-scale pillar or trench structures allows for the continuous real-time extraction of the produced isotope; a great improvement over existing target technologies. This is accomplished when the target nuclei kinematically recoil from veins 4,7 after being struck by the incident charged particle as part of being converted to the desired activation product. Most of the activated product nuclei will recoil into the gas or liquid flowing by the pillar or trench wall 3,8. The flow gas or liquid picks up the isotope and carries it out of the micro/nanostructured target. An additional technique is used to ensure that the product of activation, which is usually negatively charged, is not electrostatically drawn to the target surface lodging itself into the trench walls. This negative charge of the activation product along with positive charging from the charged particle beam causes the production products in the coolant stream to be attracted to the target material walls (trench walls) without charge neutralization. To minimize this effect, an e-gun system (a common vernacular for an electron emitting device comprised of a bias power supply and a thermoionic emitting material along with extraction lenses) is used to flood the target with electrons in a low pressure or near vacuum configuration. The e-gun electrons are not at an energy suitable to cause destruction to the surface but does impart a negative charge onto the surface of the target material. This negative charge causes the negatively charged production products to be repelled from the pillar/trench surfaces and remain in the coolant stream for charge neutralization and subsequent collection. Upon exiting the target, the negatively charged activation products are electrically neutralized by the coolant stream for later removal through a filter or aqueous bath extraction technique. The pillar 4 can be maintained at an angle with respect to the incident ion beam or parallel to the beam axis depending on the angle of the scattering reactions and energy of the particles being harnessed. The trench structure can have a flowing gaseous or liquid coolant present wherein the coolant collects the activation products which recoil out of the nanostructured device and the target apparatus is flooded by electrons provided by an electron gun wherein the electrons charge the nanostructured surfaces and repel the ionized activation products promoting higher collection efficiencies as well as decreasing the electrostatic attraction between positive and negative charges.

As shown in FIG. 8, in a truly unique nanostructured patterning, the beam energy is used to determine the maximum range the particle can travel before the energy falls below the threshold energy for transmutation/isotope production. The range of the particle beyond this point merely produces parasitic heat which is not useful for the production of isotopes. A substrate suitable 35,36 depicted as a diagonal stripe region on FIG. 8, for use at high temperature, comprised of a soluble or meltable metal or ceramic, with a melt point temperature vastly different, whose melting point is significantly below that of the target material 37, from this point depicted as a vertical stripe region on FIG. 8, are first built up or etched through with the additive/subtractive techniques described above, resulting in a repeated stack 38. The target isotope is then applied over the surface of this template 40. The target isotope is preferably manufactured through an additive growth technique selected from a group consisting of patterned chemical deposition, laser sintering, e-beam sintering, subtractive ablation, machining, or masked chemical reactive ion etching, plasma enhanced reactive ion etching, or aqueous chemical etching. This can also be accomplished by laser sintering, e-beam sintering, atomic layer deposition (ALD), MOCVD, PECVD, or a similar method. The target undergoes irradiation and active cooling as described above. However, the thickness of the target material 40 is now only a few hundred nanometers thick. The target material, when struck by the charged particle beam, recoils into the sacrificial template 39. This collects the hot isotopes and leaves behind the cold nuclei. This can be seen as the target nuclei 41 becoming activated and recoiling into the meltable substrate 39 and represented as 42. The template is then stripped using a high temperature furnace and the resultant alloy (hot radioactive nuclei and cold sacrificial template) 38 is then collected and electrically plated out. The sacrificial layers can be multiplicatively applied if the incident charged particle beam is energetic enough. The target nuclei in this instantiation are kept to the range of the recoil particle thickness and the resulting sacrificial layers will incrementally decrease in thickness as will the target nuclei. This stack repeats 37 until the charged particle energy drops below the production energy of the target. This stack improves the thermal conduction of the target as well as improves the extraction efficiency of the production technique.

### Innovative Beam Delivery

Since it is desirable to operate the system with active cooling on the front side of the target to achieve the highest possible beam currents, a unique, multiple-orifice, dynamically vacuum-pumped beam delivery system is required to create and maintain a vacuum for the beam for the longest possible time. In this innovation, the beam passes through the center of a small number of micron and sub-micron apertures in series 31. The apertures limit the amount of coolant gas or liquid which can proceed upstream toward the beam line origin, as shown in FIG. 7. These apertures are pumped dynamically using turbo molecular pumps 32 or other high volume, high vacuum system such as ion pumps or diffusion pumps and backed by a roughing pump 33. The pumps are required to pump gas volumes on the order of a factor of 10 or more above the maximum volume of coolant which can pass through a given aperture. The volume of coolant which passes through the aperture is limited by the size of the aperture, the speed of sound of the coolant, and the coolant's viscosity. This provides the means to operate the charged particle beam at pressures near perfect vacuum while it allows for dynamic cooling of the front side of the target 34 at much higher pressure.

### Self-Ablating

Another manifestation of the high current, high specific activity target is a self-ablating target. The self-ablating target allows the surface of the target to spall from the surface after the charged particle has produced the new isotopes providing fresh target material constantly while allowing for continuous, real-time removal of the production products. The charged particle beam can only penetrate to a maximum depth of several hundred microns into the target and only the first few microns of the target material interact with the charged particle beam while the incident particle energy is high enough to produce the desired activation product. The results of these collisions are energetic kinematic recoils of the target nuclei, many of which will recoil out of the target. To maximize this effect, the target material is engineered to allow it to more easily spall from the surface. This is accomplished through the creation of a lower density semi-sponge-like form of the target material. During irradiation, the target undergoes radiation damage and begins to develop charged particle ionization tracks in the target material. Most of the energy of the incident charged particle, once the charged particle energy drops below the coulomb repulsion barrier level of the target material, is deposited, via ionization events as heat in the target. These ionization tracks and the build-up of incident charged particles in the target material eventually produces embrittlement of the target material. In addition, most of the charged particle beams, for example hydrogen isotopes, helium isotopes, or carbon xenon, are gaseous when they come to rest. The entrapment of these gaseous materials in the semi-porous target material builds up pressure and increases the likelihood of fragments spalling from the surface. The novel nature of these targets are that they are engineered with lower initial density and higher porosity to produce much more rapid embrittlement, to the extent that as target nuclei are converted to the desired production product their kinematic recoil results in spallation of small fragments from the target surface. This interconnected porosity also improves collection efficiency through decreased activation energy for ablation. The target is also kept at a negative electrical potential 27 relative to the remainder of the target assembly. The negative electrical potential is used to accelerate the spalled fragments toward a sweeping magnet 29 and collection grid 28. The spalled fragments will spall with multiple agglomerated atoms present. These are additionally charged with an e-gun and accelerated to the collection grid. The grid is then later processed for the activation products. As the material spalls away and is collected by the collection grid, fresh material is exposed to the incident charged particle beam. This technique ensures nearly production and collection of product nuclei by real-time collection and a constant supply of fresh material. The collected product material can later be run through a RF ionizer and mass separator to remove any target isotopes which may have adhered onto the spallation fragments and provide the highest specific activity product isotopes possible. In a faraday cup collection mode the cold isotope prep selector accelerator (CIPSA) will have the ability to deposit the target material in a uniform fashion using the focusing/defocusing magnets. The collection mode will also allow for computer controlled steering of the focusing magnets allowing for micro and nanofeatures to be deposited allowing for a micro or nanostructured target. This coupled unit will be called the Hot isotope prep selector accelerator (HIPSA). In the faraday cup collection mode, the HIPSA will have the ability to deposit the target material in a uniform fashion using the focusing/defocusing magnets.

### Liquid Target for Online Processing

The liquid target design acknowledges that under very high beam current loadings of the accelerator, the target, even with active cooling on the face of the target, cannot dissipate heat fast enough to prevent a target from melting. The liquid target design harnesses the heat deposition to liquefy the target material and provides a means for circulation and cooling of the target material above its molten phase. Initially the target is heated through external means such as resistance or inductance heating or slowly increasing the target current until the target liquefies in its entirety. The target is heated until the loop becomes molten. Once the loop is molten, if metallic, it is circulated with a magnehtodynamic drive, natural circulation, or other impeller driven system. If electrically insulating in nature, a natural circulation, or impeller driven system is used to flow the current through the loop. External cooling is provided to remove excess heat from the system.

To provide an online means of activation product removal, either one of two techniques is used for removal of the desired radioisotope products. The first is through a selective, micro/nanostructured membrane which is operated in the coolant loop. This membrane is cloth like and created from specially tailored monomer/polymer combinations on a refractory substrate with preferential extraction of the activation product over the target materials. This membrane is cycled in and out of the target loop for online removal of the target material.

The second removal technique is applicable if the activation product has a lower melting point than the target material. A cold finger is inserted into the coolant loop and held at a constant temperature 10 C below the melting point of the activation product. The cold finger plates out the activation product leaving the target nuclei to flow by. In another instantiation, the back side of the coolant loop is heated to the boiling point of the activation product and allowed to boil off. This evaporate is then condensed in the sealed loop resulting in a high specific activity.

The last extraction technique is performed in bulk or batch mode and uses electrolysis on the molten target salt to preferentially extract the activation product from the loop. This is done online or in batch sample modes.

Significant commercial application is possible. Technitium-99m is the most widely used medical isotope in the world and is currently produced in a small number of research reactors fueled with highly-enriched uranium. Several research reactors are slated for closure in the next few years causing concern about the availability of supply of this isotope. Significant research is underway to create processes that could avoid the use of HEU and/or utilize accelerators to produce this isotope. As yet none have been successful.

Low power cyclotrons are located and used in hundreds of hospitals in the US (and worldwide) to produce low atomic number isotopes used for a variety of diagnostic techniques, e.g., fluorine-18. The present invention will allow these existing cyclotrons to be upgraded and back-fitted to allow production of Tc-99m in existing facilities, thus significantly increasing the availability and security of supply of Tc-99m available in the United States, perhaps eliminating supply concerns altogether.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

I claim:

1) A method for modifying an existing positron emission tomography (PET) cyclotron apparatus comprising:
a) an accelerator coupled to an output of the cyclotron and synchronized with a time structure of emerging protons of the output;
b) a target assembly; and
c) a nozzle,
i) wherein a first scatterer, a second scatterer, and modulator wheel are removed from the nozzle, and
ii) wherein a plurality of independently controlled radiofrequency (RF) cavities are inserted in the nozzle sequentially prior to the scanning magnets.

2) The method of claim 1 wherein the accelerator is a radiofrequency cavity (RFQ) type.

3) The method of claim 1 wherein the accelerator is a linear accelerator type.

4) The method of claim 1 wherein the accelerator operates in MHz to THz frequencies.

5) The method of claim 1 wherein the accelerator is coupled to an existing cyclotron using a drift tube.

6) The method of claim 1 further comprising a phase and RF timing modulation system which integrates monitors selected from a group consisting of: a RF pickoff from the accelerator magnetic field, a wire or multiwire beam pickoff, or a solenoid based beam detector.

7) The method of claim 1 wherein a timing modulation system is moved in and out of position, at a location selected a group consisting of a beam exiting port, an end of a pair of focusing magnets, or in the target location for the PET cyclotron.

8) The method of claim 7 wherein the target assembly and timing modulation system is cycled out of the beam line and a secondary accelerator system is installed where the aforementioned system is evacuated to vacuum in an automated fashion.

9) The method of claim 7 wherein the timing modulation system moves to the secondary accelerator assembly to the cold isotope acceleration system when not in use as an secondary accelerator.

10) The method of claim 1 wherein the target assembly is constructed to be self-shielding and a bolt-on to existing transfer mechanisms.

11) The method of claim 1 wherein the target assembly has a configuration selected from a group consisting of a solid target which is cooled dynamically with a liquid or gas, a solid ablating target, a liquid target designed for online or quasi-online processing, or a liquid target.

12) The method of claim 1 wherein the target assembly is comprised of a solid target which is micro-structured in nature for improved heat removal, improved production efficiency and improved collection efficiency.

13) The method of claim 10 wherein the micro-structured pattern is pillar/trench-like in nature and the pillar has a thickness on the order of several micrometers but less than five times the range of a charged particle beam and the trench has a width is on the order of several hundred nanometers but less than the height of the pillar.

14) A method for production of radioisotopes consisting of:
a) a target nuclei having a thickness maximally a recoil thickness of the target nuclei following reaction with the charged particle beam;
b) the target nuclei consisting of a repeating array with a sacrificial layer which can be easily separated and removed; and
c) decreasing sacrificial layer thicknesses until the thickness at which a particle incident on the surface of the nanofeature drops below the threshold production energy.

15) A method for the target used in the production of radioisotopes comprised of:
a) a solid, pore-filled target;
b) the target is micro/nanostructured to allow for ablation during irradiation the surface of the material thereby exposing unirradiated target material;
c) the target is electrically biased above the collection grid electrical potential;
d) the target is irradiated with particles selected from the group consisting of protons deuterons, tritons, or helium nuclei such that embrittlement will allow small portions of the target to spall away from the target;
e) the spalled products, which contain the desired activation products, are accelerated by the electric bias and collected through a weak bending magnet onto a collection grid.

16) The method of claim 15 wherein the spalled products are accelerated by way of electric field and focused into a dipole magnet whose field bends the fragments and atomic clusters which pass through a series of selection slits.

17) The method of claim 15 wherein the selection slits are tuned to separate cold from hot nuclei for desired activation products, 2, 3, 4 . . . n atoms of the desired activation products, or variations of desired activation products and cold isotopes. These purified sources can then be further processed to improve the specific activity of the produced isotope.

18) The method of claim 15 wherein spallation fragments can be electrostatically charged negatively by means of an e-gun to charge the spallation fragments whose charge to mass ratio is <<1 and said fragments are repelled from the surface and accelerated towards a collection grid.

19) The method of claim 15 wherein:
a) individual nanoparticles of the target nuclei are self-assembled and coated conformally with a deposition technique of atomic layer deposition forming nano-bubbles of target material.
b) as the embrittlement occurs and pressure builds, these nano-bubble capsules produced by deposition burst and allow the activation products out of the surface where the can be accelerated, ablating the surface and exposing new material for irradiation.

20) The method of claim 1 wherein an afterburner assembly, when not coupled to the PET cyclotron, can be used for cold or hot isotope separation through coupling a second high current ion source to the front end of the RFQ and a set of target mechanics to the end. This coupled unit will be called the cold isotope prep selector accelerator (CIPSA)

21) The method of claim 1 wherein the CIPSA consists of an RFQ assembly which can be tuned to either the same or different frequency used above for accelerating positive or negative ions.

22) The method of claim 21 wherein the CIPSA has attached a high current cold or hot isotope ion source.

23) The method of claim 21 wherein the CIPSA has attached after the accelerator has a drift tube coupled to a mass separator set of magnets comprised of quadrapole, sextapule, dipole and/or monopole magnets.

24) The method of claim 21 wherein a mass separator coupled to the CIPSA will have a drift tube attached with either fixed or remotely controlled apertures to specifically select isotopes of concern/desire

25) The method of claim 21 wherein the mass separator coupled to the CIPSA will have a set of focusing magnets, which can be statically, or computer controlled prior to the collection mechanism.

26) The method of claim 21 wherein the mass separator will have either collection faraday cups and/or a removable pixilated charged particle detector configured in an E+ΔE or just E detector for determination of isotopic quantification and will function as a collection mechanism.

27) The method of claim 1 wherein the entire system can be computer controlled and tuned for each individual accelerator type.

28) The method of claim wherein the computer system can also be self-adapting and learn the pulse structure of the starting cyclotron.

29) The method of claim wherein the computer system can be pre-tuned or user configured to separate and enrich multiple isotopes including cold isotopes used as target material or hot isotopes already produced.

30) The method of claim wherein the computer system will have a built in optimization routine which can control the operation of the a secondary accelerator.

31) The method of claim 1 wherein a secondary accelerator assembly, when not coupled to the PET cyclotron or being used to enrich cold isotopes, can be used for hot isotope separation through coupling a second high current ion source to the front end of the RFQ and a set of target mechanics to the end.

32) The method of claim 31 wherein the HIPSA consists of the RFQ assembly described in 1 which can be tuned to either the same or different frequency used above for accelerating positive or negative ions.

33) The method of claim 31 wherein the HIPSA has attached a high current cold or hot isotope ion source.

34) The method of claim 31 wherein the HIPSA ion source is run through an intense plasma to separate the agglomerated atoms of isotopes to produce a mono-atomic nuclei with a high charge state.

35) The method of claim 31 wherein the HIPSA has attached after the accelerator has a drift tube coupled to a mass separator set of magnets comprised of quadrapole, sextapule, dipole and/or n-pole magnets.

36) The method of claim 35 wherein the mass separator coupled to the HIPSA will have a drift tube attached with either fixed or remotely controlled apertures to specifically select isotopes of concern/desire

37) The method of claim 35 wherein the mass separator coupled to the HIPSA will have a set of focusing magnets, which can be statically, or computer controlled prior to the collection mechanism.

38) The method of claim 36 wherein the mass separator will have either collection faraday cups and/or a removable pixilated charged particle detector configured in an E+ΔE or just E detector for determination of isotopic quantification and will function as a collection mechanism.
